(19) United States
(12) Patent Application Publication
(10) Pub. No.: US 2016/0258177 A1
(43) Pub. Date: Sep. 8, 2016

(54) Transmission Pole Arm Bracket Reinforcing System

(71) Applicant: TRINITY MEYER UTILITY STRUCTURES, LLC, Dallas, TX (US)

(72) Inventors: Guy L. Faries, Memphis, TN (US); Richard M. Slocum, Cordova, TN (US); Mark H. Fairbairn, Red Wing, MN (US); Aubrey L. Jackson, Collierville, TN (US)

(21) Appl. No.: 14/425,352

(22) PCT Filed: Jan. 30, 2015
(86) PCT No.: PCT/US15/13751

§ 371 Date: Mar. 3, 2015

Related U.S. Application Data
(60) Provisional application No. 61/934,232, filed on Jan. 31, 2014.

(51) Int. Cl. E04H 12/24; F16M 13/02; H02G 7/05; E04H 12/20

(52) U.S. Cl. CPC E04H 12/24; E04H 12/20; F16M 13/02; H02G 7/05

(57) ABSTRACT

A system for reinforcing a connection mounting a transmission pole arm to a transmission pole includes at least one substantially L-shaped brace comprising two legs. The at least one brace is configured to reinforce an arm bracket of the transmission pole arm. A leg of the at least one brace comprises a cut-out section substantially corresponding to an exterior shape of the transmission pole arm.

### RELATED APPLICATION

This application claims priority to U.S. Provisional Application Ser. No. 61/934,232, entitled “TRANSMISSION POLE ARM BRACKET REINFORCING SYSTEM,” Attorney's Docket No. 091078.1855, filed Jan. 31, 2014. The contents of which are incorporated herein in its entirety by this reference.

### TECHNICAL FIELD

The present disclosure relates generally to transmission poles, and more particularly to a system and method for reinforcing an arm bracket coupling a transmission pole arm to a transmission pole.

### BACKGROUND

Utility poles, such as transmission poles, generally include arms which extend outwardly from the pole to support transmission lines. The arms are generally coupled to the transmission poles by arm brackets. When additional transmission lines need to be added to the arms, current arm brackets may require repair and/or replacement to support the additional load. The arm brackets also may require repair and/or replacement if the brackets become fatigued and/or overloaded. Any repair or replacement typically requires welding in the field by a skilled, certified welder and often presents fire and safety hazards. Moreover, the transmission pole may need to be taken out of service during the repair or replacement of the arm bracket.

### BRIEF SUMMARY

The teachings of the present disclosure relate to a system and method for reinforcing a connection mounting a transmission pole arm to a transmission pole. In accordance with one embodiment, a system for reinforcing a connection mounting a transmission pole arm to a transmission pole includes at least one substantially L-shaped brace comprising two legs. The at least one brace is configured to reinforce an arm bracket of the transmission pole arm. A leg of the at least one brace comprises a cut-out section substantially corresponding to an exterior shape of the transmission pole arm.

In accordance with another embodiment, a method for reinforcing a connection mounting a transmission pole arm to a transmission pole includes coupling at least one substantially L-shaped brace to an arm bracket of the transmission pole arm, the at least one brace configured to reinforce the arm bracket. The at least one brace comprises two legs and a leg of the brace comprises a cut-out section substantially corresponding to an exterior shape of the transmission pole arm.

Technical advantages of particular embodiments may include providing a transmission pole arm bracket reinforcing system that strengthens a connection mounting a transmission pole arm to a transmission pole. Accordingly, a transmission pole arm bracket may be able to withstand a load greater than the load it was originally designed to withstand. This may allow for additional wires to be hung from a transmission pole arm without having to replace the existing arm bracket with a stronger and/or newer arm bracket.

Further technical advantages of particular embodiments may include a transmission pole arm bracket reinforcing system that is easy to install onto existing transmission pole structures. By providing a reinforcing system that may be retrofit onto existing components of a transmission pole, the arm connection mounting the transmission pole arm to the transmission pole may be strengthened without replacing the transmission pole arm bracket, which in turn reduces the cost of maintaining transmission poles. Such a system may also reduce the amount of time and manpower required to repair and maintain transmission poles.

Another technical advantage of particular embodiments may include reinforcing and strengthening an existing transmission pole arm connection that may be fatigued and/or overloaded to ensure that the arm connection does not fail under load, which in turn prevents the transmission pole arm from breaking at the transmission pole connection.

A further technical advantage of particular embodiments may include providing a transmission pole arm bracket reinforcement system that may quickly be bolted onto an existing transmission pole arm bracket, thereby eliminating the need for field welding steel to the arm bracket. As a result, fire and safety hazards associated with maintaining transmission poles may be reduced. Moreover, such a system may eliminate the need to remove existing transmission wires and/or take the conductor associated with the transmission pole out of service during repair and/or installation.

Other technical advantages will be readily apparent to one of ordinary skill in the art from the following figures, descriptions, and claims included herein. Moreover, while specific advantages have been enumerated above, certain embodiments of the invention may include all, some, or none of the enumerated advantages.

### BRIEF DESCRIPTION OF THE DRAWINGS

The above and other features and advantages of the invention will become apparent from a consideration of the following detailed description when reviewed in connection with the accompanying drawings, in which:

FIG. 1 illustrates a perspective view of an example of a system for reinforcing a transmission pole arm bracket in accordance with an embodiment of the present disclosure;

FIG. 2 illustrates a perspective view of an example transmission pole arm bracket reinforcing system coupled to a transmission pole arm bracket in accordance with an embodiment of the present disclosure;

FIG. 3A illustrates a top view of an example transmission pole arm bracket reinforcing system coupled to a transmission pole arm bracket in accordance with an embodiment of the present disclosure;

FIG. 3B illustrates another top view of an example transmission pole arm bracket reinforcing system coupled to a transmission pole arm bracket in accordance with an embodiment of the present disclosure;

FIG. 4A illustrates a front view of an example transmission pole arm bracket reinforcing system coupled to a transmission pole arm bracket in accordance with an embodiment of the present disclosure;

FIG. 4B illustrates another front view of an example transmission pole arm bracket reinforcing system coupled to a transmission pole arm bracket in accordance with an embodiment of the present disclosure;

FIG. 5A illustrates a side view of an example transmission pole arm bracket reinforcing system coupled to a transmission pole arm bracket in accordance with an embodiment of the present disclosure;

FIG. 5B illustrates another side view of an example transmission pole arm bracket reinforcing system coupled to a transmission pole arm bracket in accordance with an embodiment of the present disclosure;

FIG. 6A illustrates a perspective view of an example brace of a transmission pole arm bracket reinforcing system in accordance with an embodiment of the present disclosure;

FIG. 6B illustrates a front view of an example brace of a transmission pole arm bracket reinforcing system in accordance with an embodiment of the present disclosure;

FIG. 7A illustrates a perspective view of an example bracket assembly of a transmission pole arm bracket reinforcing system in accordance with an embodiment of the present disclosure;

FIG. 7B illustrates a top view of an example bracket assembly of a transmission pole arm bracket reinforcing system in accordance with an embodiment of the present disclosure;

FIG. 7C illustrates a side view of an example bracket assembly of a transmission pole arm bracket reinforcing system in accordance with an embodiment of the present disclosure; and

FIG. 8 illustrates an example of a method for reinforcing a transmission pole arm bracket in accordance with an embodiment of the present disclosure.

### DETAILED DESCRIPTION

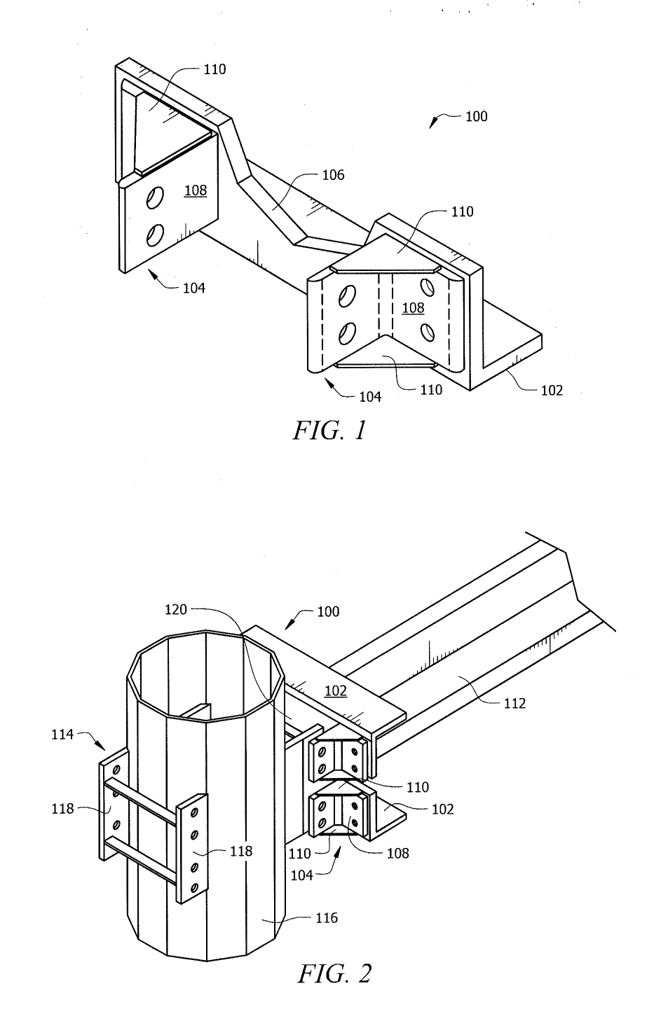

Particular embodiments and their advantages are best understood by referring to FIGS. 1 through 8 of the drawings, like numerals being used for like and corresponding parts of the various drawings.

Utility poles, such as transmission poles, generally include arms which extend outwardly from the pole to support transmission wires. The arms may be coupled to the transmission poles by arm brackets. When additional transmission wires need to be added to the arm, current arm brackets may require repair and/or replacement to support the additional load. Current arm brackets also may require repair and/or replacement if the brackets become fatigued and/or overloaded. Any repair and/or replacement typically requires welding in the field by a skilled, certified welder and often presents fire and safety hazards. Moreover, the transmission pole may need to be taken out of service during the repair or replacement of the arm bracket. The teachings of this disclosure recognize that it would be desirable to provide a system and method for reinforcing a transmission pole arm bracket that is easy to install onto existing arm structures without the need for welding, thereby reducing the costs and hazards associated with maintaining transmission poles. FIGS. 1 through 8 below illustrate a system and method for reinforcing an arm bracket coupling an arm to a transmission pole.

FIG. 1 illustrates a perspective view of an example of a system 100 for reinforcing a transmission pole arm bracket in accordance with an embodiment of the present disclosure. System 100 may include a brace 102, angle bracket assemblies 104 (“bracket assemblies 104”), a cut-out section 106, right angle brackets 108 (“angle brackets 108”), and gusset plates 110. Brace 102 and bracket assemblies 104 are generally configured to reinforce a connection mounting an arm to a transmission pole.

In general, brace 102 provides support to existing transmission pole arm structures, such as an arm bracket coupling an arm to a transmission pole. Brace 102 may be substantially L-shaped and may comprise two legs coupled together to form a substantially right angle. Example braces 102 may be made of steel, iron, aluminum, fiberglass, wood, any other suitable material, and/or any combination of the preceding. As illustrated, a leg of the brace may include a cut-out section 106 that corresponds to at least a portion of an exterior shape of an arm of a transmission pole. For example, cut-out section 106 may correspond to an upper half of an arm, a lower half of an arm, all of an arm, etc. The present disclosure contemplates system 100 comprising any number and combination of braces 102 and cut-out sections 106 having any suitable shape or configuration.

Brace 102 may be coupled to an arm bracket by bracket assemblies 104. For example, a bracket assembly 104 may be coupled to an end of brace 102 and also coupled to a side of an arm bracket, and another bracket assembly 104 may be coupled to an opposing end of brace 102 and also coupled to an opposing side of the arm bracket. Thus, bracket assemblies 104 generally facilitate reinforcing an arm bracket by coupling brace 102 to the arm bracket. According to various embodiments, bracket assemblies 104 may be coupled to the leg of brace 102 having cut-out section 106.

A bracket assembly 104 generally includes an angle bracket 108 and gusset plates 110, and may be made of steel, iron, aluminum, fiberglass, wood, any other suitable material, and/or any combination of the preceding. A gusset plate 110 may be welded to each end of bracket 108 to form bracket assembly 104. In certain embodiments, brackets 108 facilitate mounting brace 102 to the arm bracket. In such embodiments, brackets 108 may comprise mounting holes for receiving bolts to couple bracket assemblies 104 to both brace 102 and the arm bracket.

In general, the transmission pole arm bracket reinforcing system (“system 100”) of particular embodiments is easy to install using existing components of a transmission pole. System 100 may be used to add strength to an arm bracket to allow additional transmission wires to be hung from the transmission pole arm or to ensure that an existing arm bracket, which may have become fatigued over time, is reinforced so as not to fail under load. In addition, system 100 can simply and quickly be bolted onto existing transmission pole structures, eliminating any welding of components in the field.

Although FIG. 1 illustrates arm bracket reinforcing system 100 as including one brace 102 and two bracket assemblies 104, arm bracket reinforcing system 100 may include any number of braces 102, bracket assemblies 104, and other suitable components. For example, arm bracket reinforcing system 100 may comprise two braces 102 and four bracket assemblies 104. Additionally, while FIG. 1 illustrates arm bracket reinforcing system 100 as including a certain number of cut-out sections 106, angle brackets 108, and gusset plates 110, arm bracket reinforcing system 100 may include any number of cut-out sections 106, angle brackets 108, and gusset plates 110. Furthermore, although brace 102 and bracket assemblies 104 are illustrated as being separate components from each other, in certain embodiments, brace 102 and bracket assemblies 104 may be integral to or separate from any component of arm bracket reinforcing system 100. As an example, bracket assemblies 104 may be integrated with brace 102.

FIG. 2 illustrates a perspective view of an example transmission pole arm bracket reinforcing system 100 coupled to a transmission pole arm bracket in accordance with an embodiment of the present disclosure. System 100 generally refers to an arm bracket reinforcing system that may be retrofit to existing utility structures, such as an arm bracket 114 that couples an arm 112 to a transmission pole 116. Accordingly, system 100 may be used to strengthen and reinforce an existing arm bracket 114 to prevent the arm bracket from failing under load.

In the field, an arm 112 is generally coupled to a transmission pole 116 via an arm bracket 114. Arm bracket 114 may refer to a pre-existing arm connection and may include through plates 118 coupled to an arm shank 120. Through plates 118 may extend through the body of transmission pole 116. Arm shank 120 may include mounting holes to couple arm shank 120 to through plates 118. For example, arm shank 120 may include at least four mounting holes on each side to receive bolts to attach arm shank 120 to through plates 118. According to the illustrated embodiment, the mounting holes may be used to couple arm bracket reinforcing system 100 to arm bracket 114 (e.g., arm shank 120 and through plates 118), as explained below. In certain embodiments, arm shank 120 may be C-shaped (which may be interchangeably referred to as “U-shaped”). Alternatively, arm shank 120 may be any other suitable shape.

Arm 112 may be mounted to and supported by arm shank 120. In certain embodiments, mounting arm 112 to arm shank 120 may include welding an end of arm 112 to a face of arm shank 120. In operation, arm shank 120 may fail under load and thereby cause arm 112 to buckle. For example, if arm shank 120 becomes fatigued and/or overloaded, the face of arm shank 120 may yield and flex, and/or permanently deform. According to particular embodiments, system 100 may be used to reinforce and strengthen the connection between arm shank 120 coupled to through plates 118 and the outwardly extending arm 112. In other words, system 100 may reinforce and strengthen the face of arm shank 120 coupled to the end of arm 112, thereby preventing and/or fixing a failed arm shank 120 of an arm bracket 114.

In the illustrated embodiment, system 100 includes two braces 102 configured to support arm bracket 114 and four bracket assemblies 104 configured to couple braces 102 to arm bracket 114. Generally, a first brace 102 is positioned above arm 112 and a second brace 102 is positioned below arm 102. Each brace 102 may be coupled to two bracket assemblies 104. For example, a first pair of bracket assemblies 104 may be mechanically coupled to opposing ends of first brace 102 and a second pair of bracket assemblies 104 may be mechanically coupled to opposing ends of second brace 102. In certain embodiments, coupling a brace 102 to bracket assemblies 104 may refer to bolting bracket assemblies 104 to brace 102 using bolts. The present disclosure contemplates bracket assemblies 104 being coupled to brace 102 in any suitable manner.

Bracket assemblies 104 may also be coupled to arm shank 120 and through plates 118. Coupling bracket assemblies 104 to arm shank 120 and through plates 118 may comprise removing the bolts connecting arm shank 120 to through plates 118 from the mounting holes on either side of arm shank 120. Once the bolts are removed, the mounting holes of bracket assemblies 104 may be aligned with the respective mounting holes of arm shank 120 and the bolts refastened into place, thereby coupling bracket assemblies 104 to arm shank 120 and through plates 118. Thus, bracket assemblies 104 may be retrofit onto arm bracket 114 using pre-existing bolts and the corresponding bolt holes (e.g., mounting holes). The present disclosure contemplates bracket assemblies 104 being coupled to arm bracket 114 in any suitable manner.

As illustrated, bracket assemblies 104 are used to couple braces 102 to arm bracket 114, and therefore install system 100 onto arm bracket 114 to reinforce the arm connection mounting the arm to the transmission pole. Such a system for reinforcing a transmission pole arm bracket is easy to install using existing components of a transmission pole. For example, system 100 may simply and quickly be bolted onto existing transmission pole structures, which requires no welding of components in the field. Moreover, system 100 may be used to add strength to an arm bracket to allow additional transmission wires to be hung from the transmission pole arm and/or to ensure that an existing arm bracket, which may have become fatigued over time, is reinforced so as not to fail under load.

Although FIG. 2 illustrates arm bracket reinforcing system 100 coupled to a particular arm 112, arm bracket 114, and transmission pole 116, arm bracket reinforcing system 100 may be coupled to any type and any number of arms 112, arm brackets 114, and transmission poles 116. Further, although particular examples of arm 112, arm bracket 114, and transmission pole 116 have been described, this disclosure contemplates any suitable arm 112, arm bracket 114, and transmission pole 116 comprising any suitable components configured in any suitable manner, according to particular needs. In addition, arm 112, arm bracket 114, transmission pole 116, through plates 118, and arm shank 120 may be separate from or integral to any component of FIG. 2.

Moreover, while FIG. 2 illustrates arm bracket reinforcing system 100 as including two braces 102 and four bracket assemblies 104, arm bracket reinforcing system 100 may include any number of braces 102 and bracket assemblies 104. Also, braces 102 and bracket assemblies 104 may be separate from or integral to any component of arm bracket reinforcing system 100.

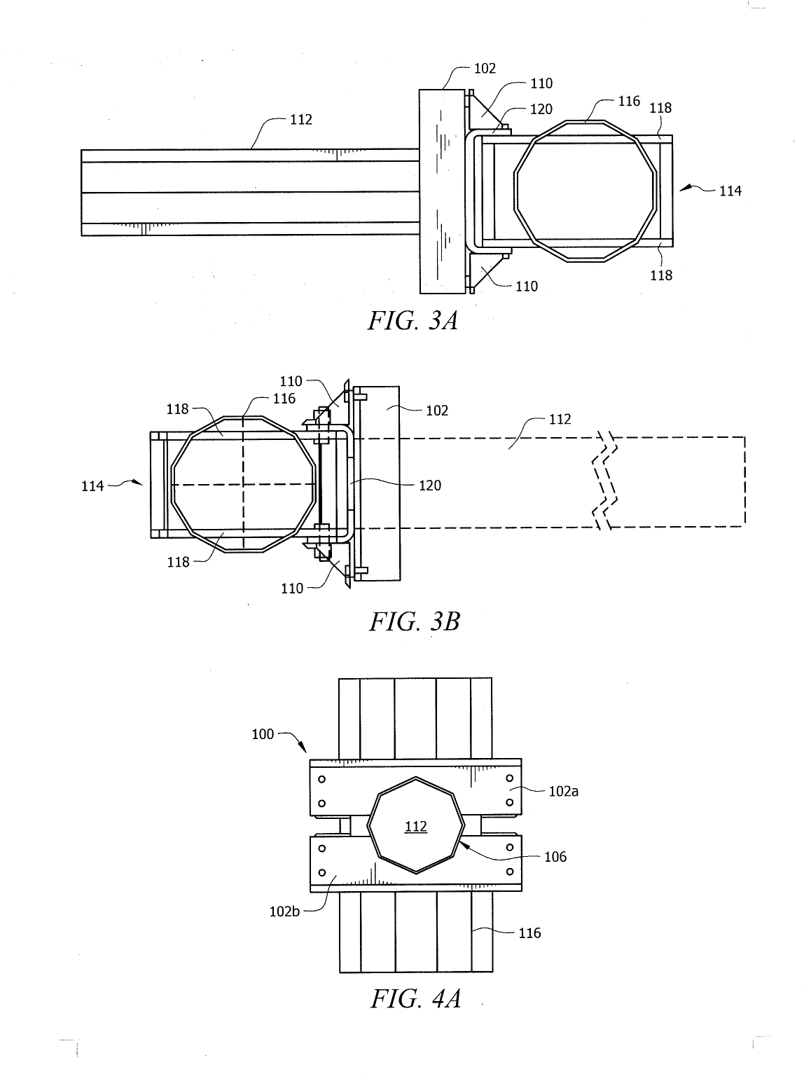

FIGS. 3A and 3B illustrate top views of an example transmission pole arm bracket reinforcing system 100 coupled to a transmission pole arm bracket in accordance with an embodiment of the present disclosure. In general, brace 102 is configured to reinforce existing structures of arm bracket 114 of transmission pole arm 112, such as arm shank 120. According to the illustrated embodiment, a brace 102 may be positioned above an arm 112 and may abut a face of an arm shank 120. Bracket assemblies 104 (not shown) comprising gusset plates 110 may couple brace 102 to arm shank 120. In certain embodiments, using brace 102 to reinforce arm shank 120 may prevent arm shank 120 from flexing and/or failing under load.

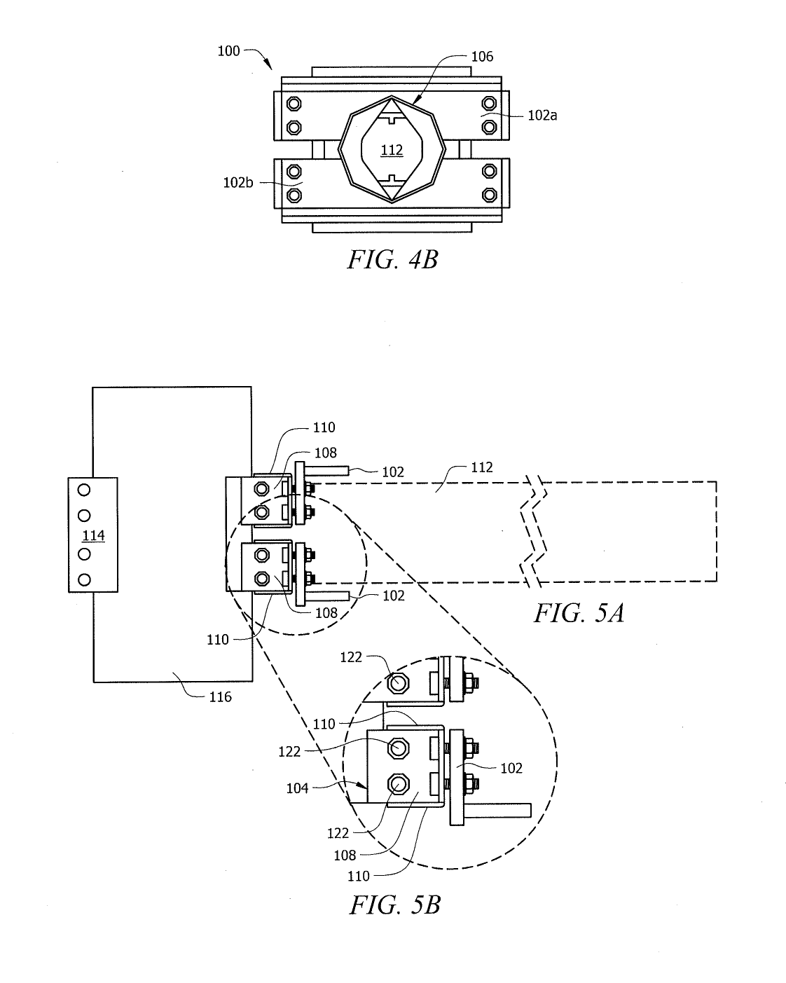

FIGS. 4A and 4B illustrate front views of an example transmission pole arm bracket reinforcing system 100 coupled to a transmission pole arm bracket in accordance with an embodiment of the present disclosure. As described above, a leg of each brace 102, such as brace 102a and brace 102b, includes a cut-out section 106. Each cut-out section 106 may substantially correspond to at least a portion of an exterior shape of a transmission pole arm 112. For example, a cut-out section 106 may correspond to at least a portion of an exterior shape of an 8-sided transmission pole arm, a 12-sided transmission pole arm, and/or any other suitable type of transmission pole arm. Although certain examples have been used to illustrate brace 102 and cut-out section 106, any suitable brace and/or cut-out section having any suitable configuration (e.g., corresponding to a particular exterior shape of a pole arm) may be used.

Braces 102a and 102b generally are configured to reinforce arm bracket 114. In an example embodiment, a brace 102a may be positioned above a transmission pole arm 112 and include a cut-out section 106 corresponding to an upper half of arm 112, and a brace 102b may be positioned below the transmission pole arm 112 and include a cut-out section 106 corresponding to a lower half of arm 112. Braces 102a and 102b may then be coupled to arm bracket 114 by bracket assemblies 104. As such, the sheer resulting from the arm and its transmission lines may be transferred from arm 112, through braces 102, then bracket assemblies 104, and into the bolts used to mount system 100 onto arm bracket 114. Therefore, the arm connection mounting the arm to the transmission pole is reinforced and strengthened by retrofitting braces 102 and bracket assemblies 104 onto arm bracket 114.

FIGS. 5A and 5B illustrate side views of an example transmission pole arm bracket reinforcing system 100 coupled to a transmission pole arm bracket in accordance with an embodiment of the present disclosure. As shown in FIG. 5A, a transmission pole arm 112 may be mounted to a transmission pole 116 by an arm bracket 114. In certain embodiments, arm bracket 114 may refer to a pre-existing arm bracket. In such embodiments, system 100 may generally be retrofit onto existing transmission pole structures.

To reinforce arm bracket 114, two bracket assemblies 104 may be mounted to opposite ends of each brace 102. Bracket assemblies 104 may be mounted to brace 102 on an outer face of a leg comprising a cut-out section 106. In certain embodiments, angle brackets 108 may facilitate coupling bracket assemblies 104 to brace 102. For example, each angle bracket 108 may comprise two members with one or more mounting holes configured to receive bolts. A first member of each angle bracket 108 of each bracket assembly 104 may be bolted to the leg of brace 102 comprising cut-out section 106 using bolts and the corresponding mounting holes.

In certain embodiments, a shim 124 (e.g., a thin slip or wedge of metal or any other suitable material) may be positioned between each bracket assembly 104 and each brace 102. Shim 124 may be used to compensate for wear, filling gaps/spaces between bracket assemblies 104 and braces 102, adjustments, and/or any other suitable purpose.

Reinforcing arm bracket 114 also includes coupling bracket assemblies 104 to arm bracket 114. Angle brackets 108 of bracket assemblies 104 may facilitate coupling bracket assemblies 104 to arm bracket 114. For example, angle brackets 108 may comprise two members with one or more mounting holes configured to receive bolts, such as bolts 122 of FIG. 5B. Accordingly, a first member of each angle bracket 108 of each bracket assembly 104 may be bolted to arm bracket 114 by bolts 122 and the corresponding mounting holes. In certain embodiments, bolts 122 may refer to one or more pre-existing bolts mounting arm 112 to transmission pole 116. In such embodiments, bolts 122 may removed from either side such that bracket assemblies 104 may be bolted into place using bolts 122 to couple bracket assemblies 104 to arm bracket 114. According to various embodiments, two bolts may be used to couple each bracket assembly 104 to arm bracket 114. Although FIGS. 5A and 5B illustrate two bolts coupling each bracket assembly 104 to arm bracket 114, it should be understood that any number of any type of bolts 122 may be used to couple each bracket assembly 104 to arm bracket 114.

By mounting braces 102 and bracket assemblies 104 to arm bracket 114, most of the load resulting from the weight of arm 112 and the corresponding transmission wires may be transferred from brace 102, through bracket assemblies 104 (including angle brackets 108 and gusset plates 110), and into bolts 122 (which may be designed to withstand that sheer). As a result, strength may be added to arm bracket 114 without having to unstring existing transmission wires, replace arm bracket 114 with a new and/or stronger arm bracket 114, and/or take the transmission pole out of service. Moreover, adding strength to an arm bracket 114 may allow additional transmission wires to be hung from an arm 112 and/or ensure that an existing arm bracket 114 does not fail under the applied load (e.g., as a result of fatigue, overload, etc.).

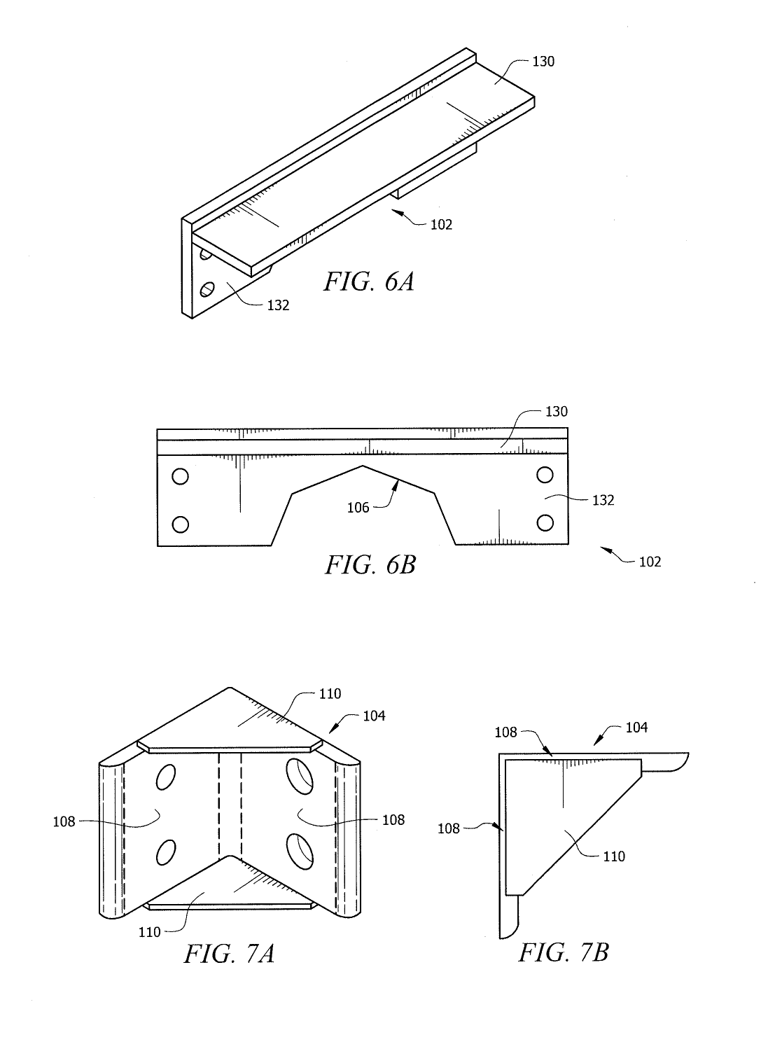

FIGS. 6A and 6B illustrate a perspective view and a front view, respectively, of an example brace 102 of a transmission pole arm bracket reinforcing system in accordance with an embodiment of the present disclosure. As shown in FIG. 6A, brace 102 may include two legs, such as a leg 130 and a leg 132. Example legs 130 and 132 of brace 102 may be made of steel, iron, aluminum, fiberglass, wood, any other suitable material, and/or any combination of the preceding. According to various embodiments, leg 130 (together with leg 132) may prevent or inhibit brace 102 from bending or twisting under load.

Leg 130 is generally coupled to leg 132 to form a right angle. Coupling leg 130 to leg 132 may include welding legs 130 and 132 together. In certain embodiments, brace 102 may refer to a pre-fabricated brace (e.g., leg 130 is coupled to leg 132 before system 100 is installed onto arm bracket 114).

As illustrated in FIG. 6B, leg 132 of brace 102 may include a cut-out section 106 that substantially corresponds to at least a portion of an exterior shape of a transmission pole arm 112. For example, cut-out section 106 may correspond to an upper half of an arm, a lower half of an arm, all of an arm, etc. Leg 132 may also comprise mounting holes for receiving bolts to couple brace 102 the bracket assemblies 104. Although certain examples have been used to illustrate brace 102, any suitable brace may be used. Further, the present disclosure contemplates brace 102 comprising any number and combination of legs 130, legs 132, and cut-out sections 106.

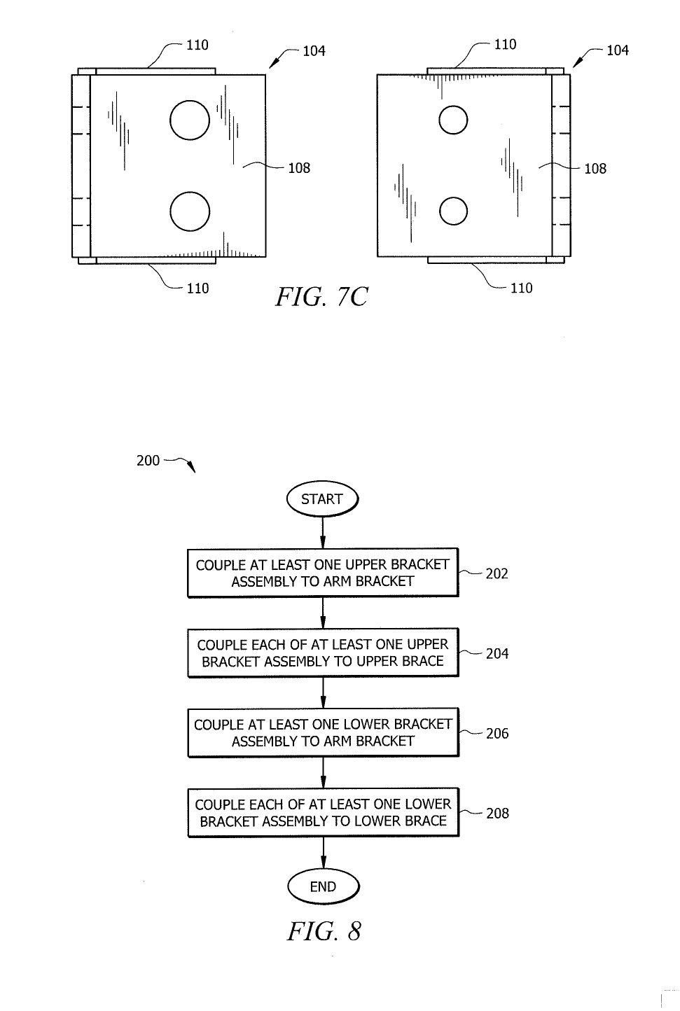

FIGS. 7A-7C illustrate a perspective view, a top view, and a side view, respectively, of an example bracket assembly 104 of a transmission pole arm bracket reinforcing system in accordance with an embodiment of the present disclosure. In certain embodiments, bracket assembly 104 may be pre-fabricated and may be made of steel, iron, aluminum, fiberglass, wood, any other suitable material, and/or any combination of the preceding.

As discussed above, bracket assembly 104 may comprise angle bracket 108 and gusset plates 110. Angle bracket 108 may be used to mount bracket assembly 104 to brace 102 and arm bracket 114. For example, angle bracket 108 may comprise two leg members with mounting holes for receiving bolts. A first member of angle bracket 108 may be used to bolt bracket assembly 104 to brace 102, while a second member of angle bracket 108 may be used to bolt bracket assembly 104 to arm bracket 114. In certain embodiments, angle bracket 108 may be formed by coupling two members together at a substantially right angle. The present disclosure contemplates angle bracket 108 being formed from any suitable shape in any suitable manner.

In certain embodiments, a gusset plate 110 may be welded to each end of angle bracket 108 to form bracket assembly 104. For example, one gusset plate 110 may be welded to the top of angle bracket 108 and another gusset plate 110 may be welded to the bottom of angle bracket 108. In such an example, gusset plates 110 may strengthen bracket assembly 104 by reinforcing the right angle joint of angle bracket 108, thereby preventing angle bracket 108 from buckling or opening up under load. Thus, gusset plates 110 may provide an easy way to facilitate retrofitting system 100 to structures that may not safely support the applied load.

As illustrated, gusset plates 110 may be triangular in shape. Alternatively, gusset plates 110 may be square, rectangular, and/or any other suitable shape. In certain embodiments, gusset plates 110 may comprise steel and/or any other suitable material, such as aluminum, iron, wood, and/or any combination of the preceding. It will be understood that the present disclosure contemplates any suitable number and combination of gusset plates 110.

In certain embodiments, a shim 124 may be positioned between angle bracket 108 and brace 102 before angle bracket 108 is bolted to brace 102. A shim 124 may be used for adjustments due to field and fabrication tolerances. In an example embodiment, shim 124 may be a metal plate having mounting holes aligned with the mounting holes of angle bracket 108 of bracket assembly 104 to receive mounting bolts. Although certain examples have been used to illustrate shim 24, any suitable shim may be used.

FIG. 8 illustrates an example of a method for installing a transmission pole arm bracket reinforcing system in accordance with an embodiment of the present disclosure. The method begins at step 202 where at least one upper bracket assembly 104 is coupled to an arm bracket 114. To couple each of the at least one upper bracket assemblies 104 to arm bracket 114, the method may use bolts 122. For example, bolts 122 connecting an arm shank 120 to through plates 118 may be removed from either side of arm shank 120 (e.g., the top bolts, such as the top two bolts, three bolts, and so on, on one or both sides of arm shank 120 may be removed from the respective mounting holes). As such, each of the at least one upper bracket assemblies 104 may be bolted into place using existing bolts 122 and thereby coupled to arm bracket 114. According to various embodiments, a first upper bracket assembly 104 may be bolted to one side of arm shank 120 (and arm bracket 114) and a second upper bracket assembly 104 may be bolted to an opposing side of arm shank 120 (and arm bracket 114). In certain embodiments, coupling each upper bracket assembly 104 to arm bracket 114 may comprise bolting a member of each upper bracket assembly 104 to arm bracket 114 at an appropriate location. It should be understood that the method may use any number and/or any type of bolts 122 to couple each upper bracket assembly 104 to arm bracket 114.

In certain embodiments, each upper bracket assembly 104 may be bolted to arm bracket 114 one at a time. For example, the method may (1) first remove one or more bolts 122 corresponding to a first upper bracket assembly 104 and bolt first upper bracket assembly 104 to arm bracket 114 using the corresponding bolts 122, (2) next remove one or more bolts 122 corresponding to a second upper bracket assembly 104 and bolt second upper bracket assembly 104 to arm bracket 114 using the corresponding bolts 122, and (3) so on (e.g., first bolts 122 corresponding to a first bracket assembly 104 are removed from arm bracket 114 and first bracket assembly 104 is bolted to arm bracket 114 by first bolts 122, then bolts 122 corresponding to a second bracket assembly 104 are removed from arm bracket 114 and second bracket assembly 104 is bolted to arm bracket 114 by second bolts 122, etc.). The method may bolt each of the at least one upper bracket assemblies 104 in any suitable order and in any suitable manner.

At step 204, at least one upper bracket assembly 104 may be coupled to an upper brace 102. For example, each of the at least one upper bracket assemblies 104 may be mounted to upper brace 102 on a face of a leg comprising a cut-out section 106. In such an example, a bracket assembly 104 may be mounted to each end of the leg of upper brace 102 comprising cut-out section 106. The method may mount each upper bracket assembly 104 to upper brace 102 in any suitable manner. As an example, each upper bracket assembly 104 may be bolted onto upper brace 102 at an appropriate location. Upper brace 102 is generally configured to reinforce arm bracket 114 of a transmission pole 112.

The method may proceed to step 206 where at least one lower bracket assembly 104 is coupled to an arm bracket 114. To couple each of the at least one lower bracket assemblies 104 to arm bracket 114, the method may use bolts 122. For example, bolts 122 connecting an arm shank 120 to through plates 118 may be removed from either side of arm shank 120 (e.g., the bottom bolts, such as the bottom two bolts, three bolts, and so on, on one or both sides of arm shank 120 may be removed from the respective mounting holes). As such, each lower bracket assembly 104 of the at least one lower bracket assemblies 104 may be bolted into place using existing bolts 122 and thereby coupled to arm bracket 114. According to various embodiments, a first lower bracket assembly 104 may be bolted to one side of arm shank 120 (and arm bracket 114) and a second lower bracket assembly 104 may be bolted to an opposing side of arm shank 120 (and arm bracket 114). In certain embodiments, coupling each lower bracket assembly 104 to arm bracket 114 may comprise bolting a member of each lower bracket assembly 104 to arm bracket 114 at an appropriate location. The method may use any number and/or any type of bolts 122 to couple each lower bracket assembly 104 to arm bracket 114.

In certain embodiments, each lower bracket assembly 104 may be bolted to arm bracket 114 one at a time. For example, the method may (1) first remove one or more bolts 122 corresponding to a first lower bracket assembly 104 and bolt first lower bracket assembly 104 to arm bracket 114 using the corresponding bolts 122, (2) next remove one or more bolts 122 corresponding to a second lower bracket assembly 104 and bolt second lower bracket assembly 104 to arm bracket 114 using the corresponding bolts 122, and (3) so on (e.g., first bolts 122 corresponding to a first bracket assembly 104 are removed from arm bracket 114 and first bracket assembly 104 is bolted to arm bracket 114 by first bolts 122, then bolts 122 corresponding to a second bracket assembly 104 are removed from arm bracket 114 and second bracket assembly 104 is bolted to arm bracket 114 by second bolts 122, etc.). It should be understood that the method may bolt each of the at least one lower bracket assemblies 104 in any suitable order and in any suitable manner.

At step 208, at least one lower angle bracket assembly 104 may be coupled to a lower brace 102 to complete installation. For example, each of the at least one lower bracket assemblies 104 may be mounted to lower brace 102 on a face of a leg comprising a cut-out section 106. In such an example, a lower bracket assembly 104 may be mounted to each end of the leg of lower brace 102 comprising cut-out section 106. The method may mount each lower bracket assembly 104 to lower brace 102 in any suitable manner. As an example, each lower bracket assembly 104 may be bolted onto lower brace 102 at an appropriate location. Lower brace 102 is generally configured to reinforce an arm bracket 114 of a transmission pole 112.

After performing step 210, the method may end.

Some of the steps illustrated in FIG. 8 may be combined, modified, or deleted where appropriate, and additional steps may also be added to the flowchart. Additionally, steps may be performed in any suitable order without departing from the scope of the disclosure. For example, the method may perform steps 206 and 208 before performing steps 202 and 204. As another example, step 204 may be performed before step 202, and step 208 may be performed before step 206.

Teachings of the present disclosure may be satisfactorily used to reinforce a connection mounting a transmission pole arm to a transmission pole. Modifications, additions, or omissions may be made to the systems described herein without departing from the scope of the invention. The components may be integrated or separated. Moreover, the operations may be performed by more, fewer, or other components. Additionally, the operations may be performed using any suitable logic comprising software, hardware, and/or other logic. As used in this document, “each” refers to each member of a set or each member of a subset of a set.

Modifications, additions, or omissions may be made to the methods described herein without departing from the scope of the invention. For example, the steps may be combined, modified, or deleted where appropriate, and additional steps may be added. Additionally, the steps may be performed in any suitable order without departing from the scope of the present disclosure.

Although particular embodiments have been described herein, a myriad of changes, variations, alterations, transformations, and modifications may be suggested to one skilled in the art, and it is intended that the present disclosure encompass such changes, variations, alterations, transformations, and modifications as fall within the scope of the appended claims.

1. A system for reinforcing a connection mounting a transmission pole arm to a transmission pole comprising:
at least one substantially L-shaped brace comprising two legs, the at least one brace configured to reinforce an arm bracket of the transmission pole arm;
wherein a leg of the at least one brace comprises a cut-out section substantially corresponding to an exterior shape of the transmission pole arm.

2. The system of claim 1, further comprising:
at least one angle bracket assembly, each angle bracket assembly of the at least one angle bracket assembly having a first member and a second member;
the first member of each angle bracket assembly coupled to the at least one brace; and
the second member of the at least one angle bracket assembly coupled to the arm bracket.

3. The system of claim 2, wherein the first member of each angle bracket assembly of the at least one angle bracket assembly is bolted to the leg of the brace comprising the cut-out section.

4. The system of claim 2, wherein each angle bracket assembly of the at least one angle bracket assembly comprises:
a right angle bracket;
a first triangular gusset plate welded to a first side of the right angle bracket; and
a second triangular gusset plate welded to a second side of the right angle bracket.

5. The system of claim 1, wherein the arm bracket is a pre-existing arm bracket.

6. The system of claim 1, wherein the arm bracket comprises a C-shaped arm shank having mounting holes thereon.

7. The system of claim 1, wherein the leg of the at least one brace comprising the cut-out section is coupled to a second leg of the at least one brace to form a right angle.

8. The system of claim 1, further comprising a shim positioned between each angle bracket assembly of the at least one angle bracket assembly and each brace of the at least one brace.

9. A method for reinforcing a connection mounting a transmission pole arm to a transmission pole comprising:
coupling at least one substantially L-shaped brace to an arm bracket of the transmission pole arm, the at least one brace configured to reinforce the arm bracket;
wherein:
the at least one brace comprises two legs; and
a leg of the brace comprises a cut-out section substantially corresponding to an exterior shape of the transmission pole arm.

10. The method of claim 9, further comprising coupling at least one angle bracket assembly to the at least one brace, the at least one angle bracket assembly having a first member and a second member.

11. The method of claim 10, wherein coupling the at least one angle bracket assembly to the at least one brace comprises bolting the first member of the at least one angle bracket assembly to the leg of the brace comprising the cut-out section.

12. The method of claim 10, further comprising coupling the at least one angle bracket assembly to the arm bracket.

13. The method of claim 12, wherein coupling the at least one angle bracket assembly to the arm bracket comprises bolting the second member of the at least one angle bracket assembly to the arm bracket.

14. The method of claim 12, wherein the at least one angle bracket assembly is coupled to the arm bracket before the at least one angle bracket assembly is coupled to the at least one brace.

15. The method of claim 12, wherein the at least one angle bracket assembly is coupled to the arm bracket using pre-existing bolts of the arm bracket.

16. The method of claim 10, further comprising positioning a shim between each bracket assembly of the at least one bracket assembly and each brace of the at least one brace.

17. The method of claim 9, wherein the at least one brace is a first brace of the at least one brace and the method further comprises:
coupling the first brace of the at least one brace to the top of the arm bracket; and
coupling a second brace of the at least one brace to the bottom of the arm bracket.

18. The method of claim 9, wherein coupling the at least one brace to the arm bracket comprises coupling the at least one brace to a pre-existing arm bracket.

19. The method of claim 9, wherein coupling the at least one brace to the arm bracket comprises coupling the at least one brace to a C-shaped arm shank of the arm bracket, the arm shank having mounting holes thereon.
